(19) United States
(12) Patent Application Publication
(10) Pub. No.: US 2009/0157423 A1
(43) Pub. Date: Jun. 18, 2009

(54) PROGRAM MANAGEMENT PROCESS FLOW

(75) Inventors: Phillip Rodney Greene, Charlotte, NC (US); William Gerald Stewart, Charlotte, NC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: National Diagnostics, Inc., Charlotte, NC (US)

(21) Appl. No.: 12/333,687

(22) Filed: Dec. 12, 2008

Related U.S. Application Data
(60) Provisional application No. 61/013,103, filed on Dec. 12, 2007.

(51) Int. Cl. G06Q 10/00; G06Q 50/00

(52) U.S. Cl. 705/2; 705/9

(57) ABSTRACT

A method for testing potential employees for predetermined medical parameters is provided and includes the steps of collecting an employee roster in an electronic database, selecting a clinic based on predetermined parameters from the electronic database, scheduling a potential employee with the clinic for testing, providing predetermined information from the electronic database to the clinic, verifying that necessary documentation is received by the clinic, receiving results of testing from the clinic, and determining if the potential employee has met predetermined medical parameters.

### PRIORITY CLAIM

This application claims priority to U.S. provisional patent application No. 61/013,103 filed on Dec. 12, 2007, and that is hereby incorporated by reference.

### TECHNICAL FIELD AND BACKGROUND OF THE INVENTION

This invention relates to a program management process flow for use in coordinating medical examinations for employees of a particular employer. More particularly, this application is directed towards a method of coordinating testing of patients for predetermined medical parameters.

Employers often require prospective and current employees to undergo drug screening to test for the use of illegal drugs. Testing for drug use is of particular importance, for example, in high stress jobs that are more susceptible to illegal drug use. Testing for drug use ensures that an employer is not only hiring employees using illegal drugs, but that employees do not become drug users after beginning employment. Some industries such as long term freight may require drivers to be drug tested pursuant to company policy or government regulations.

Typically, an employer, after reviewing and selecting potential and promising employee candidates, will set up a drug screening process with a nearby medical facility. The employer must provide the testing facility with all necessary information to do the testing, coordinate an appropriate appointment time between the employee candidate and the testing center, and process payment for the drug testing. After testing, the nearby medical facility will send the results of the test to the employer, provided that all necessary paperwork and forms are completed, and other administrative hassles are overcome. This represents a complex procedure that involves multiple parties, all of which must follow protocol to precise measures or they risk losing a file, performing the wrong test, or other administrative hassles.

Accordingly, a method for coordinating medical examinations for potential employees is needed that reduces administrative burdens and provides a more streamlines process.

### SUMMARY OF THE INVENTION

Therefore, it is an object of the invention to provide a program management process flow for use in coordinating medical examinations for employees of a particular employer.

It is another object to provide a program management process flow for use in coordinating medical examinations for employees of trucking companies.

It is another object to provide a program management process flow for use in coordinating medical examinations for employees, that reduces cost and improves efficiency.

These and other objects and advantages are set out in the following material in which a method for testing potential employees for predetermined medical parameters is provided and includes the steps of collecting an employee roster in an electronic database, selecting a clinic based on predetermined parameters from the electronic database, scheduling a potential employee with the clinic for testing, providing predetermined information from the electronic database to the clinic, verifying that necessary documentation is received by the clinic, receiving results of testing from the clinic, and determining if the potential employee has met predetermined medical parameters.

According to another embodiment of the invention, the step of scheduling a potential employee with the clinic for testing further includes the step of communicating the employee roster to a scheduling center.

According to another embodiment of the invention, the method further includes the step of outputting a notification screen on a display monitor, wherein the notification screen includes the employee roster, a schedule for the scheduling center, and a notification of scheduled service in an anticipated transactions database.

According to another embodiment of the invention, the method further includes the step of digitization of exam elements in a donor exam table after the step of verifying that necessary documentation is received.

According to another embodiment of the invention, the method further includes conducting an administrative review to determine if exam elements in a donor exam table are complete.

According to another embodiment of the invention, the step of determining if a potential employee has met predetermined medical parameters includes a first initial review to determine if predetermined medical parameters are met, and further including a second review to determine if a second testing is required.

According to another embodiment of the invention, the method further includes the step of printing instructions for the potential employee.

According to another embodiment of the invention, wherein in the step of printing instructions for the potential employee, the instructions are printed by a printer.

According to another embodiment of the invention, the method further includes the step of updating the status in the scheduling center to “pending status” after the step of verifying that necessary documentation is received by the clinic.

According to another embodiment of the invention, the method further includes the step of reporting results of the step of determining if the potential employee has met the predetermined medical parameters.

According to another preferred embodiment of the invention, a method for testing potential employees for predetermined medical parameters is provided and includes collecting an employee roster in an electronic database, scheduling a potential employee with a predetermined clinic for testing, providing predetermined information to the predetermined clinic, verifying that necessary documentation is received by the predetermined clinic, receiving results of testing, determining if the potential employee has met predetermined medical parameters, and reporting results of the step of determining if the potential employee has met the predetermined medical parameters.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIGS. 1A and 1B are a schematic diagram of the management module administrative and medical management workflow and processes;

FIG. 2 is a schematic diagram of the document management process flow;

FIG. 3 is a schematic diagram of the overall program management process flow;

FIG. 4 is a schematic diagram of the medical review process flow;

FIG. 5 is a schematic diagram of the subject scheduling process flow;

FIG. 6 is an example of an employee roster for employees at a particular employer location;

FIG. 7 is an example of a form showing a summary of services due within a predetermined future time interval;

FIG. 8 is an example of an online web notification of scheduled services form using the program management process flow;

FIG. 9 is an example of a service notification and authorization form using the program management process flow; and

FIG. 10 is an example of a service notification alert form using the program management process flow.

### DESCRIPTION OF THE PREFERRED EMBODIMENT AND BEST MODE

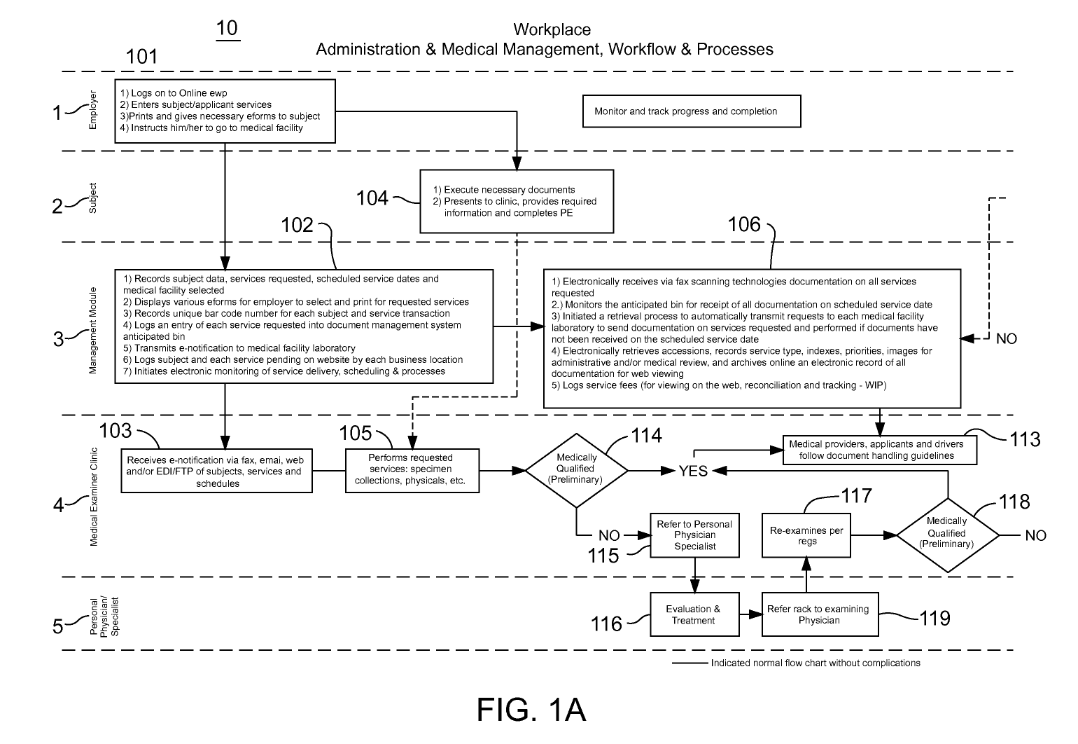

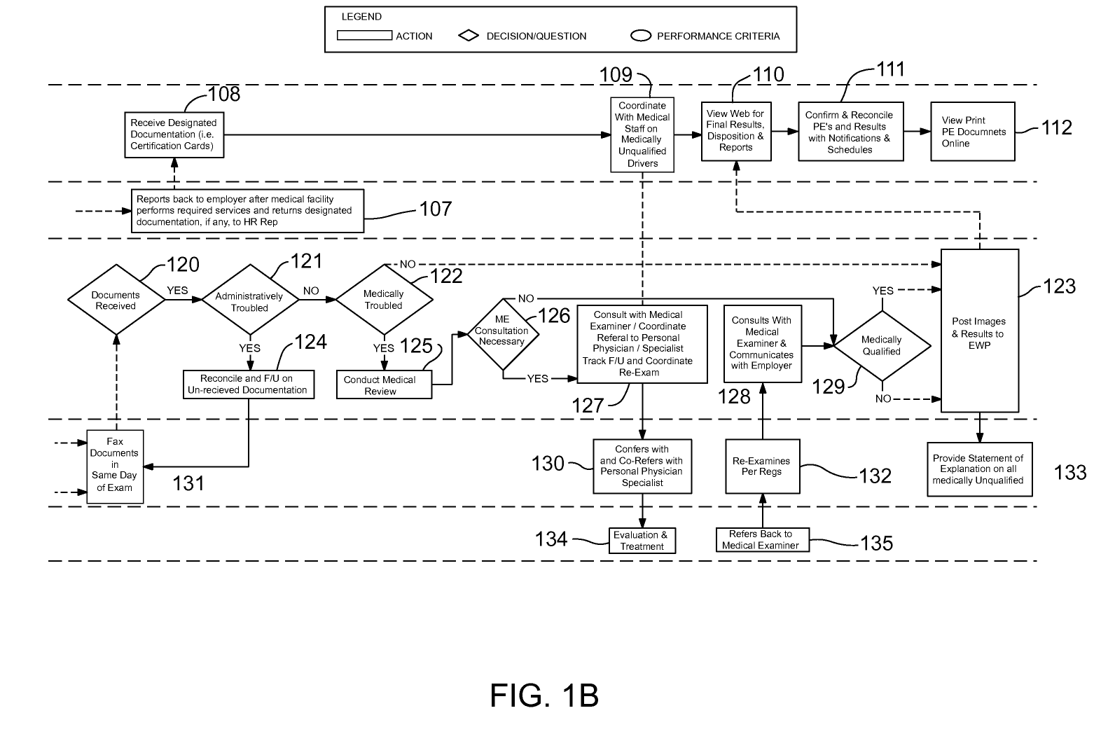

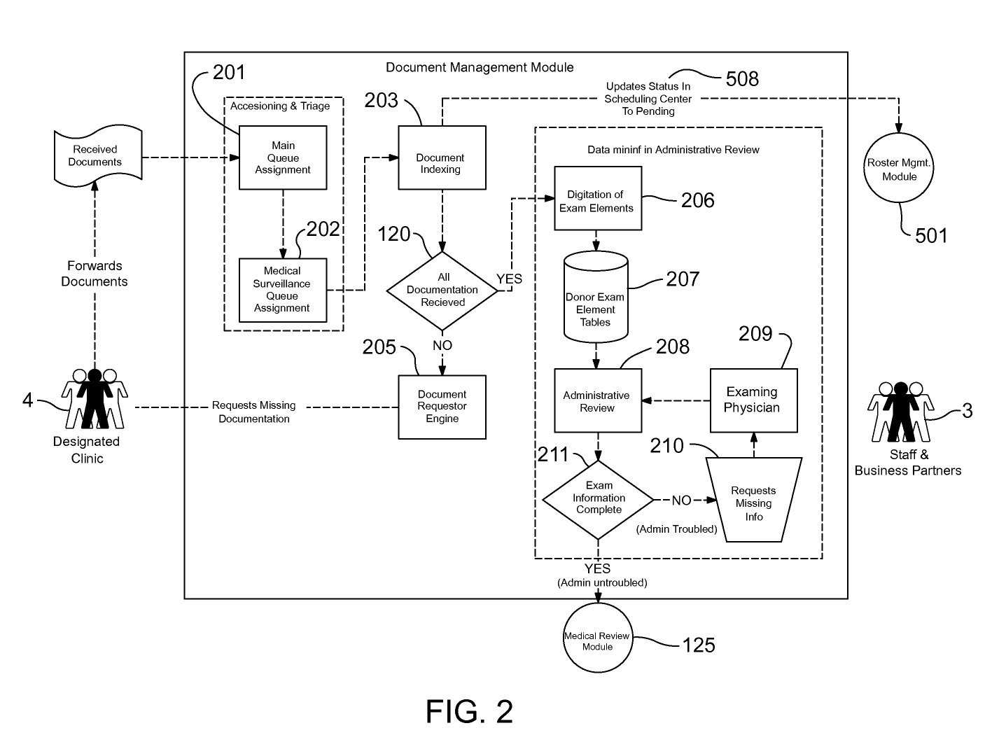

Referring now specifically to the drawings, a method of testing potential employees for predetermined medical parameters is generally designated 10, wherein identical reference elements are denoted by identical reference numbers throughout the figures. FIG. 1A and FIG. 1B show a flowchart for performing the various steps of the method 10. FIG. 1B is a continuation of FIG. 1A and may be viewed in conjunction with FIG. 1A for readability and understanding. Although the blocks of the flowchart are discussed and numbered in a certain order, they need not necessarily be performed in that order.

Operation of the method of testing potential employees 10 typically involves five actors, including an employer 1, a subject 2, typically a prospective employee, a central management module 3, a medical examiner clinic 4 where a medical examination of a subject 2 is typically performed, and a personal physician or specialist 5. The personal physician or specialist 5 may work within the clinic 4, or may work within separate facilities. The management module 3 is adapted such that multiple employers 1 can test multiple subjects 2 and send them to multiple clinics 4 or personal physicians or specialist 5. The management module preferably has internal staff who coordinate the business decisions and processes of method 10.

At 101, the employer 1 logs onto the online computer program using an ordinary computer as shown in FIG. 11 as 500. The computer 500 includes a monitor 501 and a computing system 502. The computing system 502 includes a processor, hard drive, RAM, and any other component necessary for operation. Preferably the computer program requires a preset screen name and password, and offers enhanced security protocols. The employer then enters the applicant data and services requested. Applicant data may include name, social security number, height, weight, medical history, or other preferred parameters. The employer 1 then prints and gives any necessary forms or other documentation to the subject 2. The employer 1 then instructs the subject to go to the appropriate medical clinic 4. Computer 500 may also be used for many other steps in the method that is described herein.

Upon having the applicant data entered into the computer program in 101, the information is submitted to the management module 3 at event 102. The management module 3 then records the applicant data, services requested, and scheduled service dates and clinics 4 to be utilized. The management module 3 then displays various forms for the employer 1 to select and print for requested services. The management module 3 also records a unique bar code number for each subject 2 and service transaction. The management module 3 logs an entry of each service requested into an anticipated transactions database 307. The management module 3 then transmits a notification 304 to the medical clinic 4. The management module 3 then logs subject 2 and each pending service by each business location. Finally, the management module 3 initiates electronic monitoring of service delivery, scheduling, and processes.

Also after having the applicant data entered into the computer program in event 101, event 104 is provided wherein subject 2 then executes any necessary documents. The subject 2 then presents to the clinic 4, providing required information and completes a physical exam at clinic 4.

Upon completing the steps of 102, the clinic 4 receives notifications 104 via fax, email, web, the central database, or any other known communication means of the subjects 2, services, and schedules. The clinic 4 then completes and performs the requested services in 105. The requested services may include specimen collections, physicals, routine checkups, or any other desired testing. This is accomplished in coordination with event 104 by the subject 2.

At some time after event 102, the management module 3 performs event 106. Event 106 requires that the management module 3 electronically receive documentation of all services requested. This is typically accomplished by fax, but may also be accomplished by any other communication means. The management module 3 then monitors the anticipated transactions database 307 for receipt of all documentation on scheduled service data. The management module 3 then initiates a retrieval process to automatically transmit requests to each medical clinic 4 to send documentation on services requested and performed if documents have not been received on the scheduled service date. The management module 3 then electronically retrieves, accesses, records service type, indexes, priorities, triages for administrative and/or medical review, and archives online an electronic record of all documentation for internet viewing. The management module 3 then logs service fees for viewing on the internet, reconciliation, and tracking.

After the occurrence of event 105, the clinic 4 optionally makes a decision 114 as to the preliminary medical qualifications of subject 2. If the subject 2 is not preliminary qualified according to 114, the subject 2 is then referred to a personal physician or specialist 5 for evaluation and/or treatment 116. In event 119, the subject 2 is then referred back to the examining physician making the medical qualification determination in event 114. The subject 2 is then re-examined per predetermined regulations in event 117, and a subsequent decision as to preliminary medical qualifications is made in decision 118.

If the decision 118 is that the subject 2 is preliminarily medically qualified, then, as found in event 113, the medical providers and subjects must follow the document handling guidelines found in event 106. If the decision 118 is that the subject 2 is not preliminarily medically qualified or that the subject 2 is preliminarily medically qualified, then all documentation is sent to event 131. In event 131, preferably all documentation is communicated from the medical clinic 4 to the management module 3 on the same day, and is preferably faxed, though any acceptable communication means may be employed.

The management module 3 then checks to see if documents have been received according to event 120. If the documents have not been received, then communication is effected to event 106. Event 106 then coordinates the receipt of all documents and may reinitiate event 113. If the documents have been received according to event 120, then a decision is made as to whether the subject 2 is administratively troubled according to decision 121. The decision 121 of whether the subject 2 is administratively troubled can encompass a variety of decision making criteria including documentation received, patient history, and various other subjective and objective characteristics. If the decision 121 is that the subject 2 is administratively troubled, then event 124 calls for the management module 3 to reconcile and follow up on un-received documentation. Event 124 can be coordinated with event 131 to find, prepare, and send off the necessary documents. If the decision 121 of whether the subject 2 is administratively troubled is no, then a decision 121 is reached as to whether the subject 2 is medically troubled.

If the decision 122 of whether the subject 2 is medically troubled is yes, then the management module 3 conducts a medical review 125. After the medical review 125 is conducted, the management module 3 decides whether a medical examiner consultation is required per event 126. If a medical consultation is required in event 126, the management module 3 performs the steps recited in event 127 that optionally includes a consult with a medical examiner, coordinates referral to personal physician or specialist, tracks the subject 2, follows up and coordinates re-exam. This event 127 may coincide with event 130 where the medical clinic 4 confers with and optionally co-refers with the personal physician or specialist 5. The physician or specialist 5 then provides evaluation and treatment in event 134, and subsequently refers back to the medical examiner of clinic 5 in event 135. Medical examiners of clinic 5 then re-examine the subject 4 according to predetermined parameters in event 132.

After re-examining the subject 2 according to parameters as found in event 132, the management module 3 consults with the medical examiner 4 and communicates with the employer 1 in event 128.

After consulting with the medical examiner 4 and communicating with the employer 1 in event 128, and if the question of whether a medical exam consultation is necessary as found in decision 126 is “no”, a decision 129 is made as to whether the subject 4 is medically qualified 129. Regardless of the results of whether the subject 4 is medically qualified in decision 129, the result and any corresponding images are posted to a suitable program or may be posted by fax, mail, or any other appropriate communication means. In the event that decision 129 is found to be that the subject 4 is not medically qualified, the medical examiner of clinic 4 optionally provides a statement of explanation in event 133.

In some instances, if question 120 as to whether documents have been received is no, the subject 4 reports back to employer 1 after medical clinic 4 performs required services and returns any designated document to the human resources representative of the employer 1 according to event 107. After reporting back to the employer 1 according to event 107, the employer 1 receives the designated documentation in event 108. The employer 1 then coordinates with the medical staff 4 on medically unqualified subjects 2 and may do this coordination with the management module 3 in event 127. The employer 1 then views a web display or internet viewable medium from the computer program that broadcasts the final results, disposition and reports, as produced in event 123. The employer 1 then confirms and reconciles the physical exams and results with notifications and schedules in event 111 and then views or prints physical exam documents on the computer program online in event 112.

A flow chart detailing the document management process flow is shown in FIG. 2 and is generally designated as 121 as shown in FIG. 1B. To determine if the designated clinic 4 has received documents in decision 120, a series of events are triggered. First a main queue assignment is initiated in event 201 and a medical surveillance queue assignment then occurs in event 202. Together, events 201 and 202 form an accessioning and triage. The documents are then indexed in event 203 where the documents are then updated in status in the scheduling center 303 to pending according to event 508 and such information is then sent to the roster management module. At or about the same time, a determination is again made as to whether all documentation has been received in event 204. If all documents have not been received, then a document requestor engine in event 205 requests missing documents from the designated clinic 4. If all documentation has been received, then a digitization of exam elements occurs in event 206 which is then compiled in a donor exam element table 207 and is then subject to administrative review in event 208. Subsequently in event 211, a decision is made as to whether exam information is complete in decision 211. If the decision is that exam information is not complete in decision 211, then the management module 3 requests missing information in event 210 from the examining physician in event 209. After submitting any additional missing information in event 209, administrative review 208 is performed again and repeated until exam information is complete in decision 211. The document management process flow is then in communication with the medical review module 125.

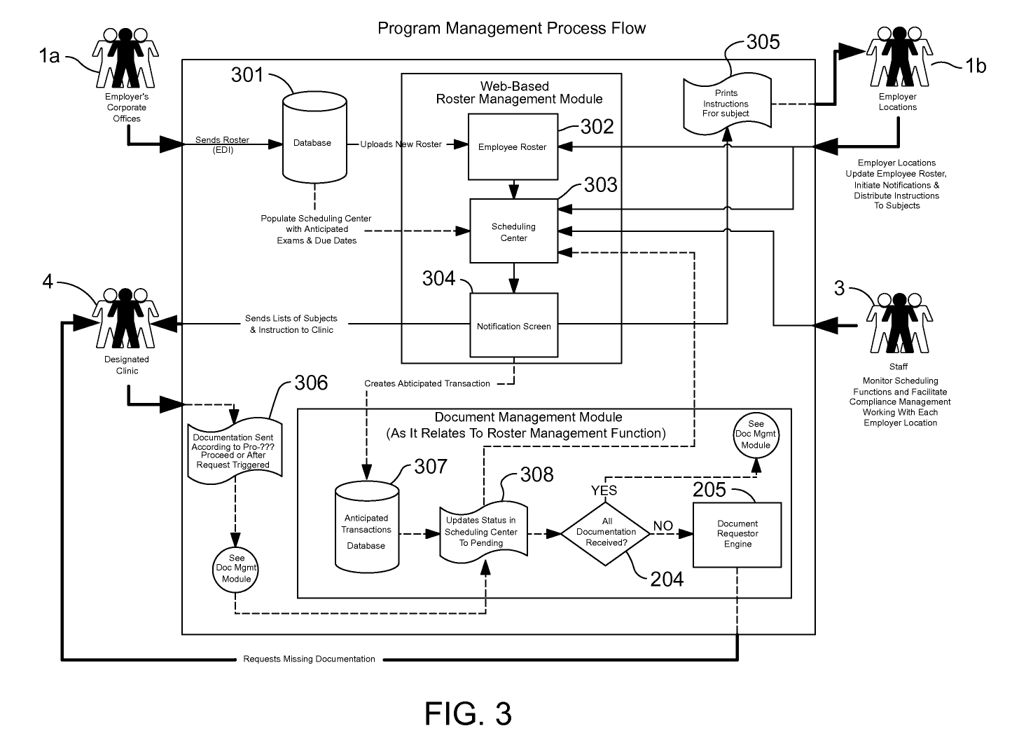

A program management process flow is shown in FIG. 3 and generally includes the employer's corporate office 1a, the employer locations 1b, staff of the management module 3, and the designated clinic 4. The employer's corporate office 1a sends a roster to the database 301. The database 301 is then uploaded into a web-based roster management module that includes an employee roster 302 that is in communication with a scheduling center 303. The scheduling center 303 then outputs a notification screen 304 that includes information such as the list of subjects to be tested 2, instructions to the clinic 4, and any other necessary medical information. The notification screen 304 is output to the designated clinic 4, and the notification screen 304 provides an indication of the anticipated transaction to the anticipated transactions database 307 found in the document management module as it relates to roster management function. The anticipated transactions database 307 is in communication sufficient to update status in the scheduling center 303 to pending as shown in 308 which is then communicated back to the scheduling center 303. Events 204 and 205 are carried out as discussed with regards to FIG. 2.

The notification screen 304 is in communication with event 305 that prints instructions for subject 2 at the employer's location 1b. The employer's location 1b updates the employee roster, initiates notifications, and distributes instructions to subjects 2 and then communicates back with the employee roster 302 and the scheduling center 303. The staff of the management module 3 monitor scheduling functions and facilitate compliance management working with each employer location 1b in communication with the scheduling center 303.

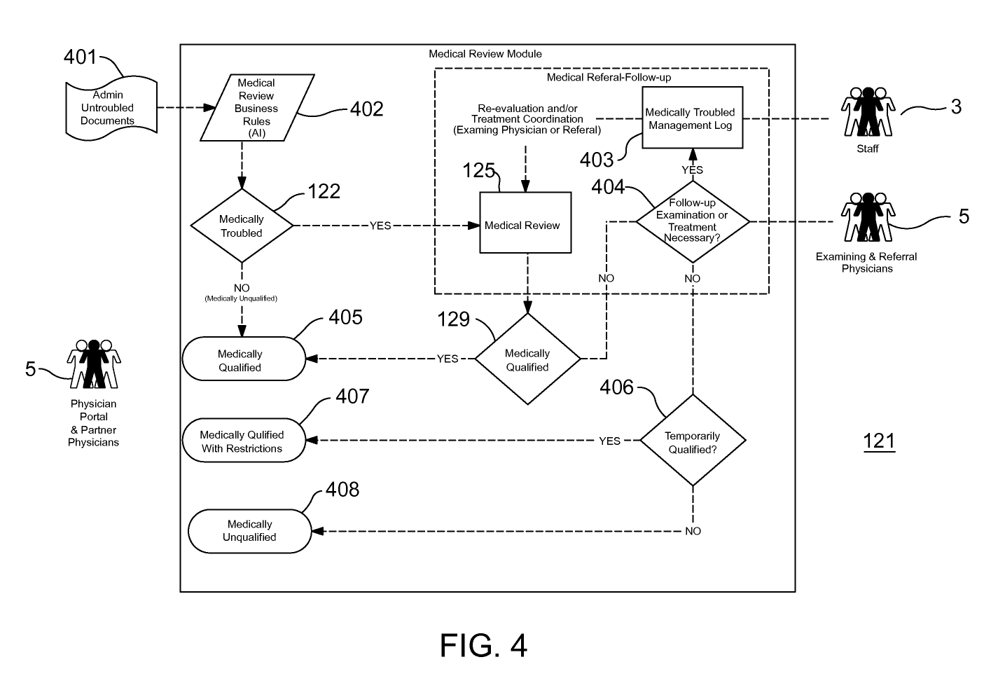

A medical review process flow is shown in FIG. 4 and generally encompasses the steps of receiving administratively untroubled documents 401 in the administratively troubled decision 121 as shown in FIG. 1B. If administratively untroubled documents 401 are present, a medical review occurs in event 402 and a decision as to whether the subject 2 is medically troubled occurs in decision 122 as shown in FIG. 1B. If the subject 2 is medically troubled, then the medical review event 125 is initiated to determine if the subject 2 is medically qualified in event 129. If the subject 2 is medically qualified, then a decision of “medically qualified” 405 is determined. This decision of “medically qualified” 405 is also reached if the subject 2 is not medically troubled in decision 122. If the subject 2 is not medically qualified, then a decision as to whether a follow-up examination or treatment may be necessary is provided in decision 404. If a follow-up examination or treatment is necessary in decision 404, then a medically troubled management log 403 is created for the subject 2. This log 403 is communicated to the staff 3 and then a re-evaluation and/or treatment coordination by the examining physician or referral physician occurs. This log is then transmitted to medical review event 125 and the procedures previously discussed for event 125 are followed again. If the follow-up examination or treatment is not necessary in decision 404, then the subject 2 may be determined to be temporarily qualified in decision 406. If the subject 2 is determined to be temporarily qualified in decision 406, then a decision of “medically qualified with restrictions” 407 is determined. If the subject 2 is determined to not be temporarily qualified in decision 406, then a decision of “medically unqualified” 408 is determined.

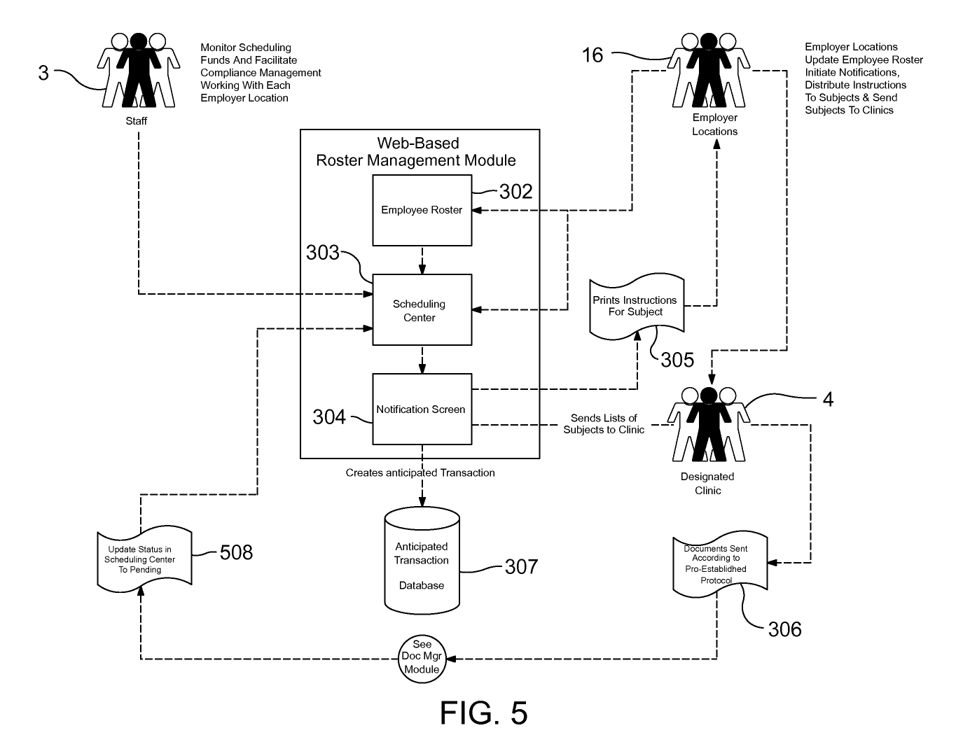

A subject scheduling process flow is shown in FIG. 5 and generally includes the management module staff 3, the employer locations 1b and the designated clinic 4. The subject scheduling process flow works in coordination with the events depicted in FIG. 3. The staff 3 monitors scheduling functions and facilitates compliance management working with each employer location 1b in coordination with the scheduling center 303. The employer locations 1b update the employee roster 302, initiate instructions, distribute instructions to subjects 2, and send subjects 2 to clinics 4. The employee roster 302 is then communicated to the scheduling center 303 and then notification screen 304 is then displayed. Instructions are then printed according to 305 and provided to the employer locations. The notification screen 304 then creates an anticipated transaction in the anticipated transactions database 307. The notification screen 304 is operable to send a list of subjects to the designated clinic 4, which then sends documents according to pre-established protocol in event 306. This is communicated to the document management module which then updates status in the scheduling center 303 to pending according to event 508.

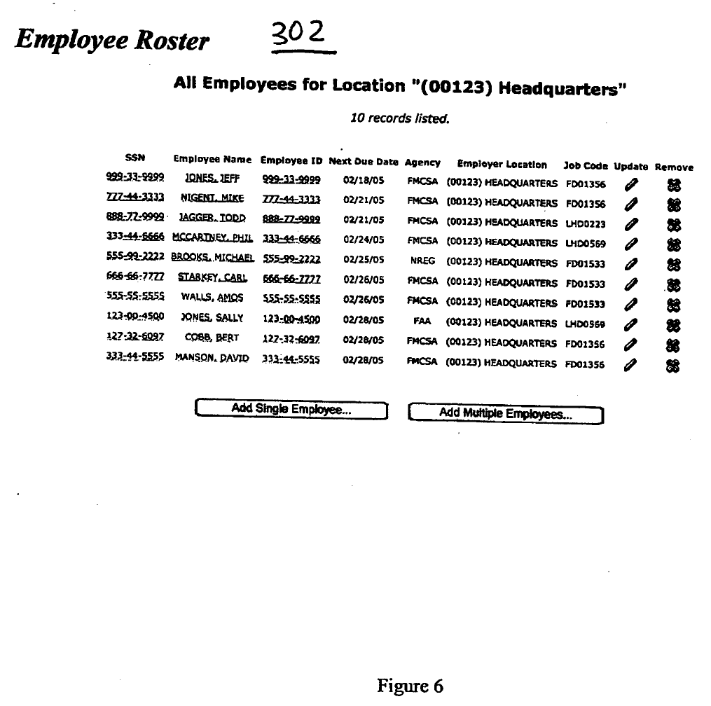

A sample of the employee roster 302 is provided in FIG. 6. The employee roster 302 may include information such as the social security number of the subject 2, subject name, subject ID, relevant upcoming dates, agency, employer locations, job code, or other desired variables.

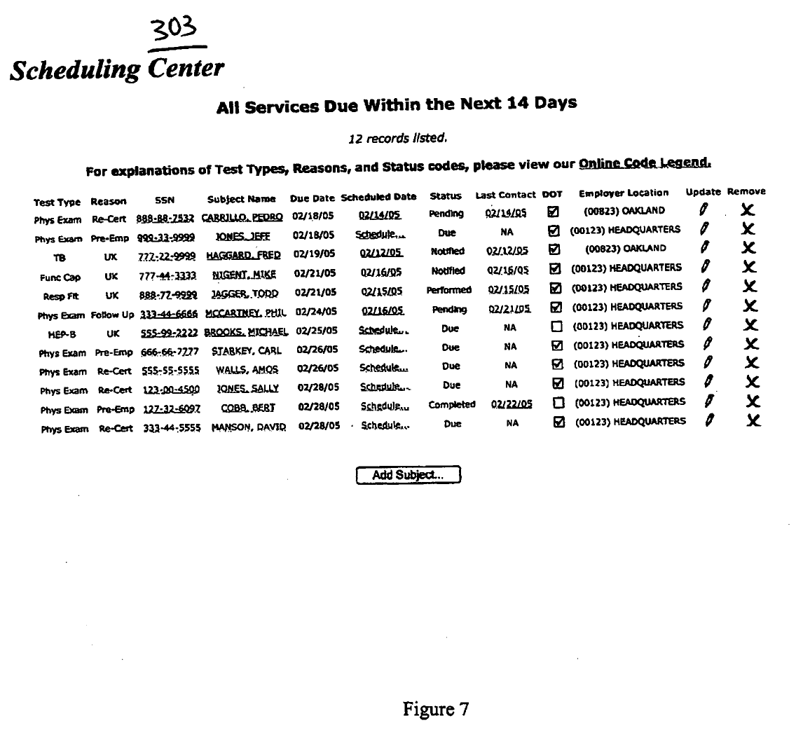

A sample of a scheduling order issued from the scheduling center 303 is provided in FIG. 7. The scheduling order 303 may include information such as the test to be performed, the social security number of the subject 2, subject name, subject ID, relevant upcoming dates, agency, employer locations, job code, or other desired variables.

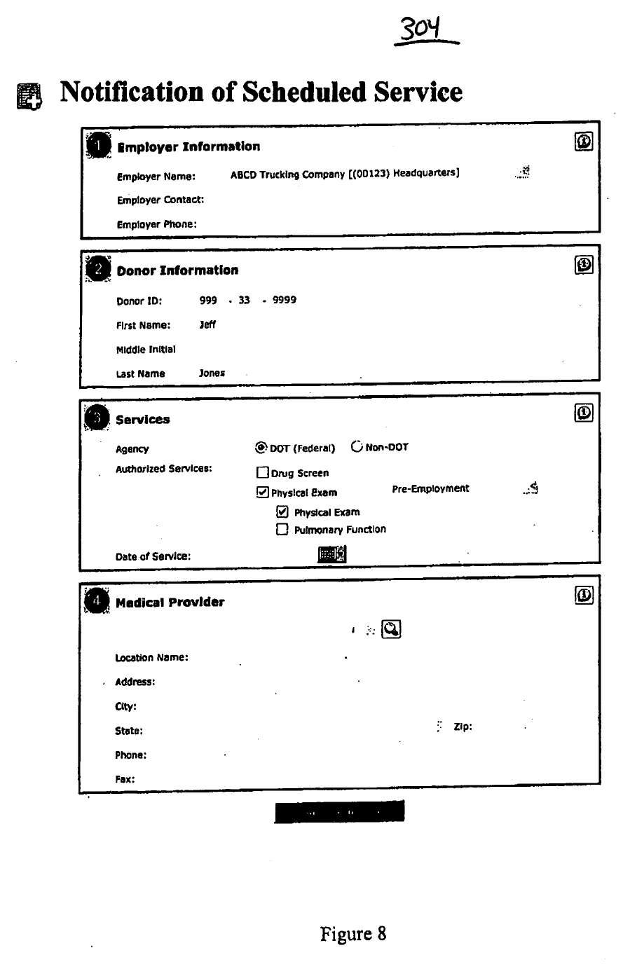

A sample of a notification of scheduled service 304 is provided in FIG. 8. The notification 304 may include employer information, donor information, services, medical provider, or any other desired parameter. This form would be found as part of notification screen 304.

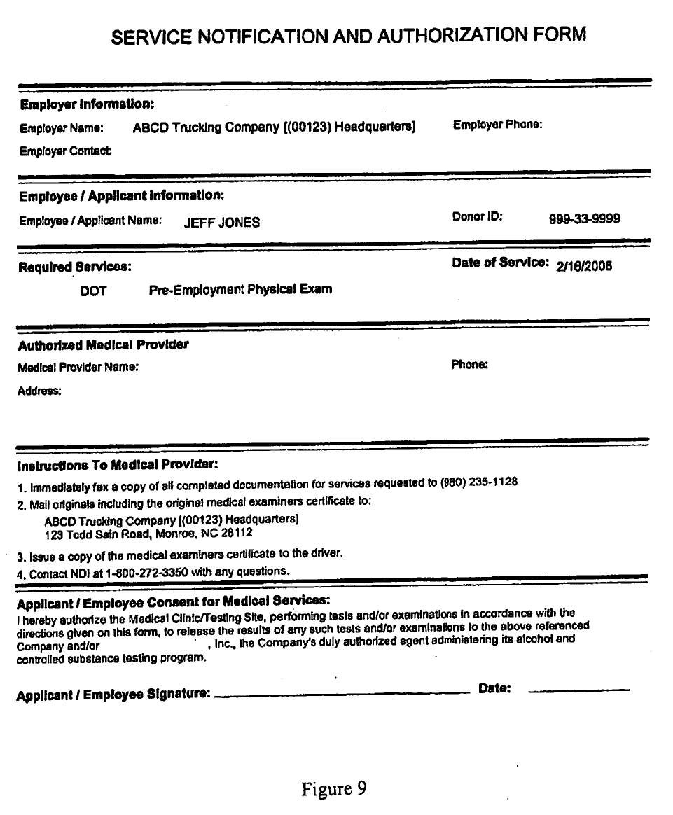

A sample of a service notification and authorization form is provided in FIG. 9. The authorization form is representative of a form that a subject 2 would execute in event 104 before going to the clinic 4 for examination. This form would be found as part of notification screen 304.

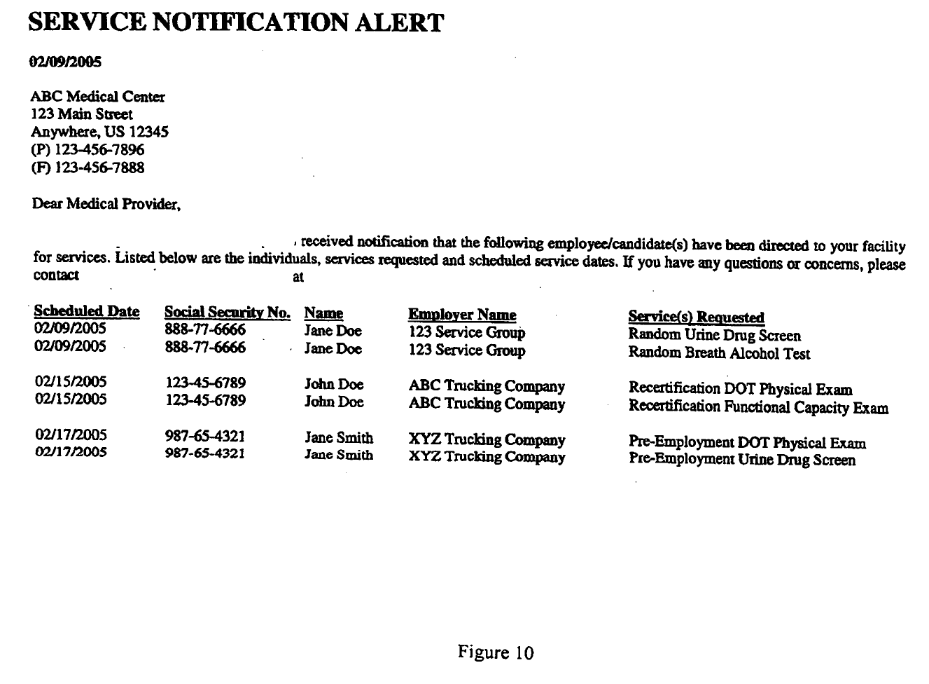

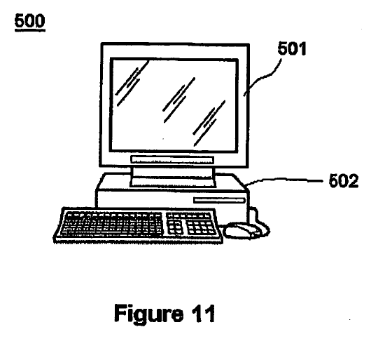

A sample service notification alert that would also be part of the notification screen 304 is provided in FIG. 10. This notification alert would be sent to the designated clinic 4 to alert the clinic 4 of scheduled examinations.

An method of testing potential employees is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

We claim:

1. A method for testing potential employees for predetermined medical parameters, comprising:
collecting an employee roster in an electronic database;
selecting a clinic based on predetermined parameters from the electronic database;
scheduling a potential employee with the clinic for testing;
providing predetermined information from the electronic database to the clinic;
verifying that necessary documentation is received by the clinic;
receiving results of testing from the clinic; and
determining if the potential employee has met predetermined medical parameters.

2. The method according to claim 1, wherein the step of scheduling a potential employee with the clinic for testing further includes the step of communicating the employee roster to a scheduling center.

3. The method according to claim 2, further including the step of outputting a notification screen on a display monitor, wherein the notification screen includes the employee roster, a schedule for the scheduling center, and a notification of scheduled service in an anticipated transactions database.

4. The method according to claim 1, further including the step of digitization of exam elements in a donor exam table after the step of verifying that necessary documentation is received.

5. The method according to claim 4, further including conducting an administrative review to determine if exam elements in a donor exam table are complete.

6. The method according to claim 1, wherein the step of determining if a potential employee has met predetermined medical parameters includes a first initial review to determine if predetermined medical parameters are met, and further including a second review to determine if a second testing is required.

7. The method according to claim 1, further including the step of printing instructions for the potential employee.

8. The method according to claim 7, wherein in the step of printing instructions for the potential employee, the instructions are printed by a printer.

9. The method according to claim 2, further including the step of updating the status in the scheduling center to “pending status” after the step of verifying that necessary documentation is received by the clinic.

10. The method according to claim 1, further including the step of reporting results of the step of determining if the potential employee has met the predetermined medical parameters.

11. A method for testing potential employees for predetermined medical parameters, comprising:
collecting an employee roster in an electronic database;
scheduling a potential employee with a predetermined clinic for testing;
providing predetermined information to the predetermined clinic;
verifying that necessary documentation is received by the predetermined clinic;
receiving results of testing;
determining if the potential employee has met predetermined medical parameters; and
reporting results of the step of determining if the potential employee has met the predetermined medical parameters.

12. The method according to claim 11, wherein the step of scheduling a potential employee with a predetermined clinic for testing further includes the step of communicating the employee roster to a scheduling center.

13. The method according to claim 12, further including the step of outputting a notification screen on a display monitor, wherein the notification screen includes the employee roster, a schedule for the scheduling center, and a notification of scheduled service in an anticipated transactions database.

14. The method according to claim 11, further including the step of digitization of exam elements in a donor exam table after the step of verifying that necessary documentation is received.

15. The method according to claim 14, further including conducting an administrative review to determine if exam elements in a donor exam table are complete.

16. The method according to claim 11, wherein the step of determining if a potential employee has met predetermined medical parameters includes a first initial review to determine if predetermined medical parameters are met, and further including a second review to determine if a second testing is required.

17. The method according to claim 11, further including the step of printing instructions for the potential employee.

18. The method according to claim 17, wherein in the step of printing instructions for the potential employee, the instructions are printed by a printer.

19. The method according to claim 12, further including the step of updating the status in the scheduling center to “pending status” after the step of verifying that necessary documentation is received by the clinic.
